(19) United States
(12) Patent Application Publication
(10) Pub. No.: US 2007/0052686 A1
(43) Pub. Date: Mar. 8, 2007

(54) Input device

(75) Inventor: Tomoo Nomura, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/500,302

(22) Filed: Aug. 8, 2006

(30) Foreign Application Priority Data
Sep. 5, 2005 (JP) 2005-256488

(51) Int. Cl. G09G 5/00

(52) U.S. Cl. 345/173

(57) ABSTRACT

An input device having a touch pad that senses a touch of a finger for selectively providing plural types of instructions for a coupled apparatus includes a finger type recognition unit for recognizing a finger type of a finger that is sensed by the touch pad and an instruction output unit for outputting the instruction according to the finger type recognized by the finger type recognition unit.

### CROSS REFERENCE TO RELATED APPLICATION

This application is based on and claims the benefit of priority of Japanese Patent Application No. 2005-256488 filed on Sep. 5, 2005, the disclosure of which is incorporated herein by reference.

### FIELD OF THE INVENTION

The present invention generally relates to an input device for use in a vehicle.

### BACKGROUND OF THE INVENTION

In recent years, various input devices are used to input data and/or an instruction to apparatus such as a computer, a calculator, a cellular phone, or the like. A specific operational function is assigned to each key of a keypad in the input device for inputting, for example, numbers or instructions. Thus, a user of the computer uses the key to input a desired number or a desired command when he/she gives a specific instruction for the computer.

The input device for inputting the instruction includes a touch switch used, for example, in a navigation system. The touch switch senses a touch on the switch for receiving instructions from the user. The touch switch is disposed as a touch panel on a display unit of the navigation system. The position of the touch on the touch panel is sensed by an optical sensor, and the touch is inputted as a corresponding instruction to the navigation system.

The position of the touch on the touch panel for a specific instruction is guided by a key or a button displayed at an arbitrary position on the display unit. Further, a touch-sensitive area being defined as a specific portion of the touch panel serves as an input button on the display unit. Japanese patent document JP-A-2002-108544 discloses an input device that is separately disposed from the display unit for the ease of operation. Japanese patent document JP-A-2001-143077 discloses a personal identification authorization device for verifying a user based on an input of a fingerprint of the user.

The input device such as a keyboard or the like uses a preset function assigned to each of the keys on the keyboard. Therefore, the user basically confirms the position of each of the keys on the keyboard before pressing each key except for acquiring/using the dexterity of a blind touch input method or the like. The same situation is observed for the input by using the touch panel on the display unit. That is, when the operation on the touch panel is guided by predetermined menu buttons or the like displayed on the display unit, the user has to confirm the position of the menu buttons before actually touching them.

However, the confirmation of the position of the menu buttons on the display unit leads to a dispersed attention of the user (e.g., a driver of the vehicle). Further, a hierarchical structure of menus due to a limitation of a display space on the display unit leads to repetitive operations of the menu buttons on the display unit, thereby increasing the chance of the dispersion of the driver's attention away from the driving operation. This is because the driver has to watch the display unit very carefully to confirm the position of menu buttons whenever he/she operates the menu button in each of the menu hierarchies. Therefore, the confirmation of the position of the menu buttons required prior to the actual operation of the button in each of the hierarchical menus for operating, for example, the navigation system in the vehicle is not desirable.

### SUMMARY OF THE INVENTION

In view of the above-described and other problems, the present disclosure provides an input device that allows a user to input various instructions by a touch operation without confirming a position of an input menu button on a display unit for a brevity of operational procedure.

The input device having a touch pad that senses a touch of a finger for selectively providing plural types of instructions for a coupled apparatus includes a finger type recognition unit for recognizing a finger type of the finger that is sensed by the touch pad and an instruction output unit for outputting instruction according to the finger type recognized by the finger type recognition unit. In this manner, the input of the instruction from the user is complete without regard to a position of the touch on the touch pad. In other words, the user needs not confirm the position of the touch on the touch pad. Therefore, the input device is used to simplify the input operation of the user.

In another aspect of the present disclosure, the input device detects a finger type that can be combined with the position of the touch on the touch pad for outputting various instructions for the apparatus. In this manner, a limited space of the touch pad is used for receiving various inputs for providing instructions.

Further, the input device may be disposed separately from the coupled apparatus, or may be disposed integrally with the coupled apparatus depending on an input situation.

Furthermore, the input device may recognize a fingerprint of the user for distinguishing the finger that touched the touch pad. In this manner, a finger type is distinguished for later use in the input device.

Furthermore, the input device may recognize a shape of the hand for distinguishing the finger that touched the touch pad. In this manner, the finger type is distinguished for later use in the input device.

The input device having the above-described feature is used to eliminate a confirmation operation for confirming the position of the touch. Therefore, the input device is preferably used for inputting instructions for a car navigation system or a personal computer.

### BRIEF DESCRIPTION OF THE DRAWINGS

Other objects, features and advantages of the present invention will become more apparent from the following detailed description made with reference to the accompanying drawings, in which:

FIG. 1 shows a flowchart of an operation process of an input device in a first embodiment of the present disclosure;

FIGS. 2A and 2B show illustrations of a touch pad in combination with a camera in the input device;

FIG. 3A shows a perspective view of a touch pad of the input device used for controlling a navigation system in a vehicle;

FIG. 3B to 3D show tables of operations for specific functions of the navigation system;

FIG. 4 shows a flowchart of an operation process of the input device used in a personal computer in a second embodiment of the present disclosure; and

FIG. 5 shows a table of operations for a specific input of the personal computer.

### DETAILED DESCRIPTION OF THE PREFERRED EMBODIMENTS

Embodiments of the present disclosure are described with reference to the drawings. The embodiments of the present disclosure are not necessarily limited to the types/forms in the present embodiment, but may take any form of the art or technique that is regarded within the scope of the present disclosure by artisans who have ordinary skill in the art.

### First Embodiment

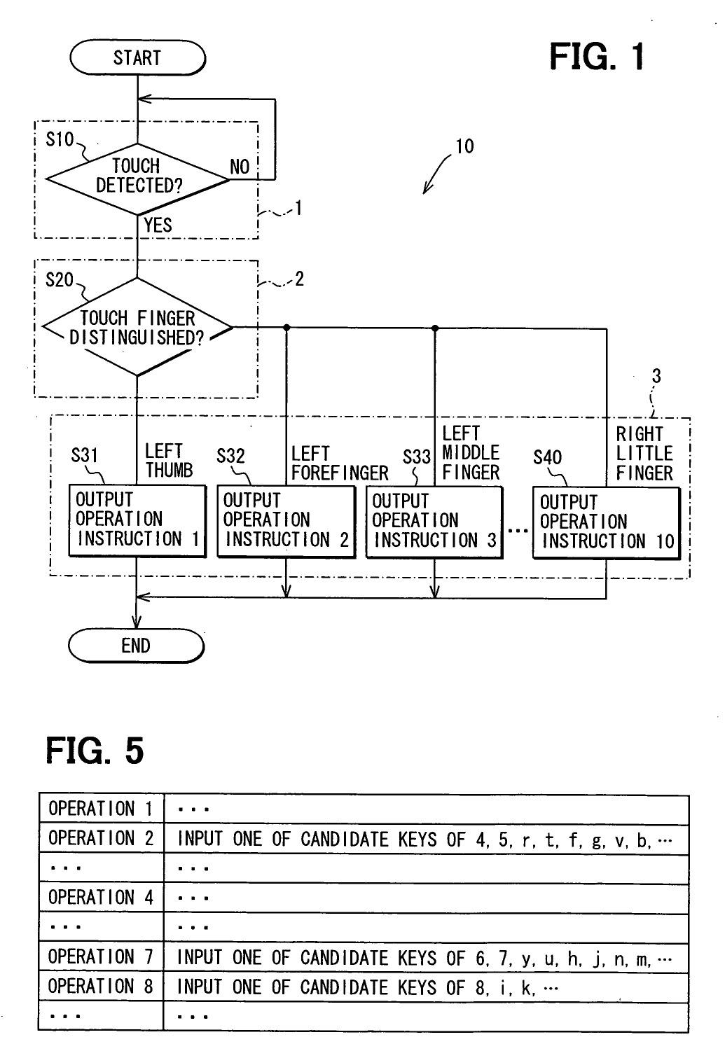

FIG. 1 shows a flowchart of an operation process of an input device 10 in a first embodiment of the present disclosure. In this flowchart, each of the steps in the flowchart are associated with a component/function of the input device 10. That is, step S10 is a function of a touch pad 1, step S20 is a function of a camera 2a, or 2b, and steps S31 to S40 are a function of an instruction input device 3. Details of the components and functions are described later in the first embodiment.

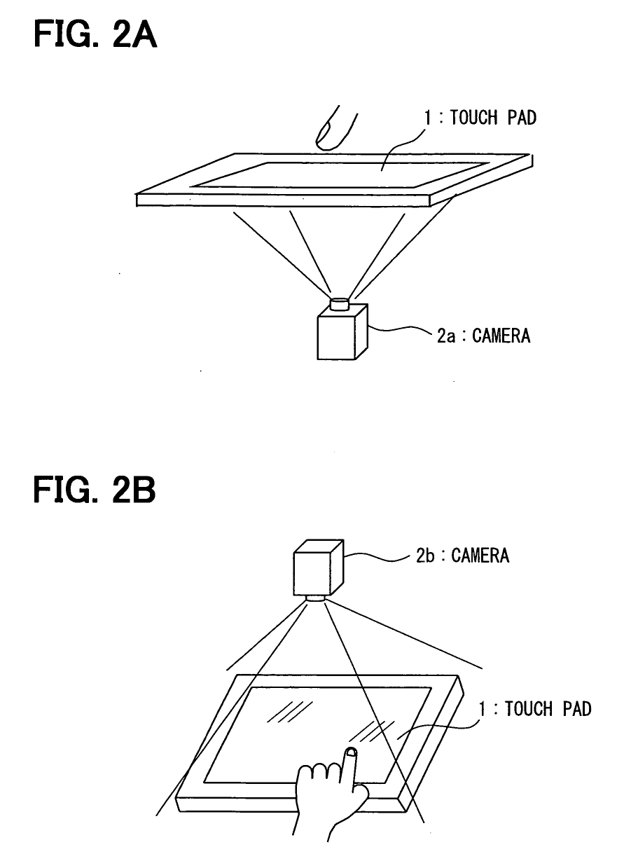

FIGS. 2A and 2B show illustrations of the touch pad 1 in combination with the cameras 2a and 2b in the input device 10. The cameras 2a, 2b are used for recognizing a finger type used for inputting the instruction.

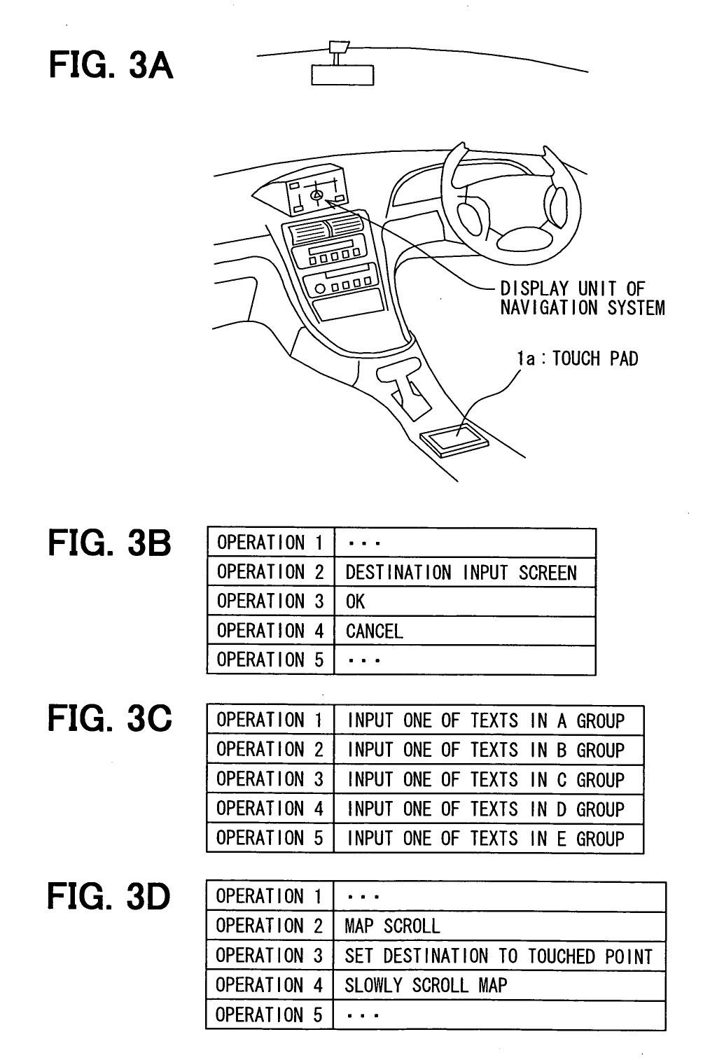

FIG. 3A shows a perspective view of the touch pad 1 of the input device 10 used for controlling a navigation system in a vehicle.

As the arrangement of the figure indicates, the input device 10 of the present disclosure is described in conceptual aspects in the first place by using a flowchart, and then in implementation aspects in the succeeding descriptions with reference to illustrations and tables.

The input device 10 of the present disclosure is coupled with an apparatus in a vehicle and is used for inputting an instruction for the apparatus. Therefore, in step S10 in the flowchart in FIG. 1, the operation process detects a touch on the touch pad 1 for detecting a user input (step S10:YES). The process proceeds to step S20 when the touch is detected. The process repeats step S10 when the touch is not detected (step S10:NO).

Then, in step S20, the process detects a touch finger that is used to touch the touch pad 1 by using the camera 2a or 2b.

Then, in either of steps S31 to S40, the process outputs an operation instruction in association with the touch finger from an instruction output unit 3 based on the detection of the touch finger in step S20. That is, one of an operation instruction 1 to an operation instruction 10 in association with one of ten fingers in both hands is executed based on the touch finger detected in step S20.

The input device 10 may have a touch position sensor (not shown in the figure) for detecting a touch position of the touch provided by the user on the touch pad 1. The touch position sensor associates a combination of the touch finger and the touch position with at least one specific instruction of the apparatus for controlling the apparatus.

The camera 2a or 2b in the input device 10 is used to detect a fingerprint of the user for identifying the touch finger as a fingerprint authentication device detects the fingerprint for identifying the user. That is, the fingerprint of the touch finger is used to detect the touch finger by imaging the finger print by the camera 2a in FIG. 2A from the other side of the touch pad 1. The fingerprint may also be recognized by the touch pad 1 itself when the resolution of touch pad 1 is sufficiently high for analyzing the fingerprint.

The touch finger may be detected by the camera 2b in FIG. 2B. In this case, the camera 2b captures a form of a hand of the user including shapes of the fingers by using, for example, an infrared sensor or the like. The touch on the touch pad 1 is associated with the touch finger based on the shape of the finger at the time of the touch on the touch pad 1.

The touch pad 1 of the input device 10 in FIG. 1 may be disposed as a separate touch pad 1a in FIG. 3 for controlling the navigation system. That is, the touch pad 1a is used to remotely control a display screen of the navigation system for the ease of operation. The position of the touch pad 1a may be on the left side or on the right side of a driver depending on the user's preference. The touch pad 1a may also be disposed on the display screen as a conventional navigation system when it makes the operation of the navigation system easier.

The operation 1 to operation 10 in FIG. 10 may be defined as the operations in the tables in FIGS. 3B to 3D. More practically, the table in FIG. 3B is an example of navigation system control commands for controlling the navigation system. The table in FIG. 3C is an example of character input arrangement assigned to the operations 1 to 5 when the navigation system is displaying a character input screen. The table in FIG. 3D is an example of map control command when the touch pad 1a is disposed on the display screen of the navigation system. The driver of the vehicle can select and execute a desired operation from among the operations in the tables in FIGS. 3B to 3D by touching the touch pad 1a with the touch finger that is in association with the desired operation. The input of the desired operation completes when the driver touches the touch pad 1a. For example, the driver can provide character input for the navigation system easily and fluently by using the touch pad 1a without watching the display screen. In this case, the touch on the touch pad 1a may be anywhere on the touch pad 1a for inputting the character. Further, the input of the character by the selective use of the touch fingers improves safety condition in driving because the driver operation or driver's attention may less likely be interrupted nor distracted by the touching operation.

The input device 10 of the present embodiment detects the touch finger by using the camera 2a or 2b, and executes the corresponding operation in association with the touch finger. In this manner, the driver or the user of the apparatus coupled with the input device 10 can complete the input operation only by touching the touch pad 1a without confirming the touch position on the display screen.

The input device 10 of the present embodiment may be use in the following manner when the input device 10 is equipped with the touch position sensor. More practically, the desired operation is assigned to a combination of the touch position in the touch pad 1a and the touch finger. Therefore, the input device 10 in FIG. 1 is efficiently operable in terms of the space assigned for each of the desired operation because a single button space may be associated with various operations depending on the combination of the same space with different fingers.

In addition, the space on the touch pad 1a may be utilized in an efficient manner when the limitation of the space on the touch pad 1a demands a hierarchical menu structure. That is, repetitive input operations for drilling down the hierarchical menu structure due to the limitation on providing plural buttons in one screen may be eliminated because of the assignment of different operations to a single button. Furthermore, the confirmation of the input position in each of the input operations is eliminated at the same time, thereby improving the safety condition in driving because of the decreased chances of distraction.

The input device 10 of the present embodiment provides an input method that requires no confirmation operation or less frequent confirmation operations of the input position on the display screen. Therefore, the input method provided the input device 10 has an advantage for use with the navigation system or the like because the input method does not or is less likely to compromise the driving operation of the vehicle by the driver.

### Second Embodiment

A second embodiment of the present disclosure is described with reference to the drawings. In the second embodiment, the input device 10 is used for inputting characters to a personal computer. That is, the input device 10 is used as a keyboard of the personal computer. In the second embodiment, like number is used to indicate like component in the first embodiment.

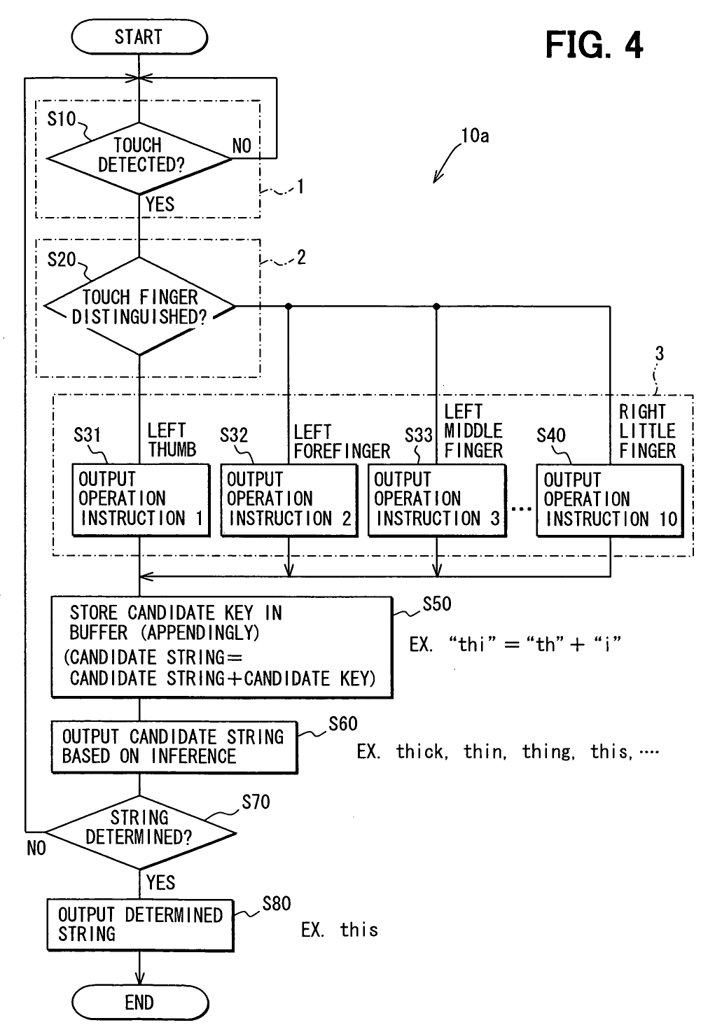

FIG. 4 shows a flowchart of an operation process of the input device 10a used with the personal computer. FIG. 5 shows a table of operations for a specific input of the personal computer provided by the input device 10a.

An upper half of the flowchart in FIG. 4 describes the input method of the input device 10a. The input method of the input device 10a is same as the input device 10 described in the first embodiment with reference to the flowchart in FIG. 1. Therefore, detailed description of the upper half of the flowchart in FIG. 4 is omitted.

A lower half of the flowchart in FIG. 4 describes a blind touch input method for inputting a character from the input device 10a. The assignment of the character to each operation in association with the touch by the touch finger is summarized as the table in FIG. 5. For example, the touch on the touch pad 1 by the forefinger of the right hand is cyclically used as an instruction for inputting a character of 6, 7, y, u, h, j, n, or m as indicated in a row of an operation 7 of the table in FIG. 5. In this manner, the touch pad 1 of the input device 10a is used as the keyboard in a flat shape for receiving a blind touch by the user. That is, the touch pad 1 serves as a virtual keyboard for accepting an input of the user without using a mechanical switch.

In step S50, the operation process of the input device 10a stores inputted characters, i.e., a text string, in a buffer of the input device 10a. The input device 10a is equipped with an inference engine for facilitating the input operation.

In step S60, the process outputs a candidate for succeeding input on the display screen based on the inference by the inference engine. That is, the text string in the buffer is compared with a dictionary in a controller of the input device 10a, and similar strings are provided as input candidates.

In step S70, the process determines the text string intended by the user. The process proceeds to step S80 when the user affirmatively determines the text string inferred by the controller (step S70:YES). The affirmative determination may be provided by the user with, for example, a combination of the two fingers (e.g., simultaneous touches of the little fingers on both hands). The process returns to step S10 for repeating the input operation when the user negatively determines the text string provided by the inference (step S70:NO).

In step S80, the process outputs the determined text string to the personal computer.

The input device 10a in FIG. 4 serves as a virtual keyboard in a small space. The smallness of the input device 10a provides an increased flexibility for design and styling. The touch pad 1 made of a film type material may be used for disposing the input device 10a on clothes such as a pair of trousers or the like, or on a fabric of a bag or the like. In this case, the touch pad 1 having the high resolution may be used to distinguish the finger type based on the recognition of the fingerprint on each finger.

The input device 10 of the present disclosure has an advantage that allows the user for inputting various operation instructions by the touch operation on the touch pad 1 without confirming the touch position. Therefore, the input method by using the input device 10 has a wide range of applications for providing instructions for the apparatus in the vehicle or the like.

Although the present disclosure has been fully described in connection with the preferred embodiments thereof with reference to the accompanying drawings, it is to be noted that various changes and modifications will become apparent to those skilled in the art.

For example, the cyclical provision of input candidates may be changed or re-arranged by the user for improving the efficiency of the input. More practically, an operation 9 may be used to input a character of a, s, d, f, g, h, or j.

Such changes and modifications are to be understood as being within the scope of the present invention as defined by the appended claims.

What is claimed is:

1. An input device having a touch pad that senses a touch of a finger for selectively providing plural types of instructions for a coupled apparatus, the input device comprising:
a finger type recognition unit for recognizing a finger type of the finger that is sensed by the touch pad; and
an instruction output unit for outputting at least one of the plural types of the instructions according to the finger type recognized by the finger type recognition unit.

2. The input device as in claim 1 further comprising:
a touch position detection unit for detecting a position of a touch on the touch pad,
wherein the instruction output unit outputs at least one of the plural types of the instructions according to the position to the touch detected by the touch position detection unit in association with the finger type recognized by the finger type recognition unit.

3. The input device as in claim 1,
wherein the touch pad is disposed separately from a display unit that displays an operational condition of the apparatus.

4. The input device as in claim 1,
wherein the touch pad is disposed integrally on a top of the display unit that displays an operational condition of the apparatus.

5. The input device as in claim 1,
wherein the finger type recognition unit recognizes the finger type of the finger that is sensed by the touch pad based on a detection of a fingerprint of the finger.

6. The input device as in claim 1,
wherein the finger type recognition unit recognizes the finger type of the finger that is sensed by the touch pad based on a detection of a shape of a hand projected onto the touch pad when the touch is sensed by the touch pad.

7. The input device as in claim 1,
wherein the apparatus is a car navigation system.

8. The input device as in claim 1,
wherein the apparatus is a personal computer.

9. A method for providing plural types of instructions for a coupled apparatus based on a touch of a finger on a touch pad comprising:
detecting a finger type of the finger based on the touch on the touch pad; and
associating the finger type detected by the touch pad with the instruction,
wherein at least one of the plural types of the instructions in association with the finger type detected by the touch pad is provided for the coupled apparatus.

10. The method as in claim 9 further comprising:
detecting a position of the touch on the touch pad,
wherein at least one of the plural types of the instructions is provided for the coupled apparatus based on the finger type detected by the touch pad and the position of the touch.

11. The method as in claim 9,
wherein the finger type is detected based on a fingerprint sensed by the touch pad.

12. The method as in claim 9,
wherein the finger type is detected based on a shape of a hand sensed by the touch pad.

13. The method as in claim 9,
wherein the coupled apparatus is a car navigation system.

14. The method as in claim 9,
wherein the coupled apparatus is a personal computer.
